(19) United States
(12) Patent Application Publication
(10) Pub. No.: US 2014/0227393 A1
(43) Pub. Date: Aug. 14, 2014

(54) Process for preparing a functional fermented milk product with low acidity and containing a low content of lactose and enhanced with galactooligosaccharides and Bifidobacterium, and functional fermented milk product prepared therewith

(71) Applicant: A.G.V. PRODUCTS CORP., CHIAYI (TW)

(72) Inventors: KWAN-HAN CHEN, Taipei City (TW); CHUN-LIANG CHOU, Chiayi City (TW); CHIEN-TENG FAN, Chiayi County (TW); NIEN-CHEN LIN, New Taipei City (TW); CHIEN-YU CHEN, Chiayi City (TW); HUI-MIN LAI, Chiayi County (TW)

(21) Appl. No.: 14/175,729

(22) Filed: Feb. 7, 2014

(30) Foreign Application Priority Data
Feb. 8, 2013 (TW) 102105402

(51) Int. Cl. A23C 9/127

(52) U.S. Cl. CPC A23C 9/1275
USPC 426/43; 426/580

(57) ABSTRACT

The present invention relates to a process for preparing a functional fermented milk product with low acidity and containing a low content of lactose and enriched with galactooligosaccharide and Bifidobacterium, and functional fermented milk product prepared therewith. The process is characterized by converting lactose in milk materials to galactooligosaccharide before subjecting the milk materials to lactic fermentation. The process is further characterized by adding fructooligosaccharide to milk materials before subjecting the milk materials to lactic fermentation; the addition of fructooligosaccharide promotes growth of Bifidobacterium during lactic fermentation and increases the amount of galactooligosaccharide in the final product.

### CROSS-REFERENCE TO RELATED APPLICATIONS

This application claims priority to Taiwanese Patent Application No. 102105402, filed Feb. 8, 2013, the entire contents of which are incorporated herein by reference.

### FIELD OF THE INVENTION

The present invention relates to a process for preparing a functional fermented milk product with low acidity and containing a low content of lactose and enhanced with galactooligosaccharides and Bifidobacterium, and functional fermented milk product prepared therewith.

### BACKGROUND OF THE INVENTION

Among the various kinds of milk products, yogurt drinks have the longest history. Yogurt drinks are made from milk, which is a highly nutritious food containing many important nutrients, including proteins, calcium and vitamins. Fermentation of milk by lactic acid bacteria confers the milk with unique flavors and makes the milk to be absorbed more efficiently. After fermentation, large molecules in the milk are digested to become small molecules, which results in a reduction of the lactose level, an increase of the free amino acid level and the production of folic acid and vitamin K; which makes the milk suitable for human use. The lactic acid released during the fermentation process is in association with calcium to form calcium lactate, which is absorbable and digestible to humans. In addition, the ratio of phosphorus and calcium in yogurt drinks is similar to that in human bone. Therefore, yogurt drinks are a good source of calcium.

Probiotics are one or more microorganisms which promote the quality of intestinal flora and the intestinal health of human or animal hosts. The most commonly used probiotic strains are lactic acid bacteria. Lactic acid bacteria have many advantages, including easing lactose intolerance, improving immunity, inhibiting pathogens, improving nutritional values of food, lowering the cholesterol level and resisting tumors. Probiotics have a long history of use, and have been considered very safe for human use.

Lactic acid bacteria are bacteria that conduct carbohydrate fermentation to produce a large amount of lactic acids. Lactic acid bacteria have the following common characteristics: (1) being non-motile Gram-positive bacteria, (2) having complex nutritional requirements, including carbohydrates, amino acids, nucleic acid derivatives, vitamins and various nutritional factors, (3) usually lacking catalase activity and cytochrome, (4) capable of growing in anaerobic, microaerobic, aerotolerant anaerobic or facultative anaerobic environment, preferably in anaerobic or obligate anaerobic environment.

There are many species of lactic acid bacteria. According to a long-term usage and the result of research, it has been found that some species of lactic acid bacteria constitute normal intestinal flora and are functional (i.e., having potential being probiotics). Some lactic acid bacteria such as Lactobacillus bulgaricus, Streptococcus thermophilus,

Lactobacillus acidophilus and Bifidobacterium bifidum are common lactic acid bacteria. Bifidobacterium is the most advantageous genus of lactic acid bacteria in human gut. The temperature that is optimal for lactic acid bacteria to conduct fermentation and produce lactic acid is generally between 30° C. to 45° C.

Prebiotics are non-digestible and non-absorbable ingredients that stimulate the growth and/or activity of one or more microorganisms in the digestive system. Common prebiotics include fructooligosaccharide (FOS), galactooligosaccharide (GOS), isomaltooligosaccharide (IMO) and xylooligosaccharide (XOS). Since the oligosaccharide prebiotics contain glycosidic bonds with beta linkages, they largely resist hydrolysis by human intestinal glycolytic enzymes, which mainly cleave alpha linkages. A combination of probiotics and prebiotics will arrive at synergistic efficacy, and such synergistic combination is called synbiotics. In vitro and in vivo experiments show that prebiotics promote the growth and physiological functions of probiotics.

GOS is a low calories carbohydrate, which has about 50% calories compared to other general carbohydrates. GOS maintains stable under heat and acid. GOS promotes intestinal peristalsis and gastrointestinal function like plant fiber does. GOS is the most important oligosaccharide component in breast milk. It is disclosed in references that GOS has proliferative effects on Bifidobacterium bifidum and lactic acid bacteria in gut and fulfills the criteria of prebiotics classification.

In the commercially available fermented milk products, only 20% to 30% lactose is converted to small molecules, so the lactose content is high. In addition, according to the process of preparing fermented milk disclosed in prior art, oligosaccharide prebiotics are additionally added to promote the growth of probiotics. The prior art does not teach or suggest treating the milk materials to obtain oligosaccharide prebiotics during the process of producing functional fermented milk products.

ROC Patent Application No. 099127616 discloses a complete nutritional composition for reducing the symptoms of allergies in different groups of patients comprising Lactococcus strains or probiotic. The composition comprises a probiotic of the genus Lactococcus.

ROC Patent Application No. 091134913 discloses a yogurt formula for inhibiting Helicobacter pylori. The invention of ROC Patent Application No. 091134913 is characterized by adding 10⁵ CFU/ml to 10⁹ CFU/ml Bifidobacterium lactis (Bb-12) and 0.02% to 0.08% GOS to maintain the amount of bacterial until the end of the storage period.

WO 2004/052121 A1 discloses a prebiotic composition comprising, per 100 mL, from about 1 g to about 3 g FOS and from about 2 g to about 20 g GOS; both the FOS and GOS have a degree of polymerisation ranging from about 2 to about 7. Compared to the use of the prebiotic alone, the combinational use of FOS and GOS in a weight ratio FOS: GOS from about 0.01 to about 50 synergistically promotes the growth of Lactobacilli.

US 2011/0,189,148 A1 discloses methods and compositions for treating symptoms associated with lactose intolerance and for overall improvement in gastrointestinal health. The composition is in the form of milk products, flavored-milk, yogurt or a yogurt drink. US 2011/0,189,148 A1 discloses a composition with decreased lactose content in combination with effective amounts of prebiotics and/or probiotics. The composition comprises 0.01% to 5% (w/w) lactose per 240 mL serving. The composition comprises Lactobacillus or Bifidobaterium or a mixture thereof as probiotics and FOS, GOS, and XOS as prebiotics.

JP 11-075774 discloses the application of GOS in yogurt products. JP 11-075774 concerns an invention relating to the addition of GOS in a sugar-free fermented milk product so that the product is capable of promoting intestinal health. In addition, JP 11-075774 discloses adding GOS in fermented milk or a yogurt drink.

ROC Patent Application No. 099127161 discloses a process for preparing milk products with high GOS content and low lactose content, wherein the process is characterized by directly treating milk materials with a lactase. ROC Patent Application No. 099127161 does not disclose further treating the milk products with probiotics nor does it disclose the production of a functional fermented milk product with low acidity, low lactose content and enhanced with GOS and Bifidobacterim.

There exists a need of a method of producing fermented milk products which can efficiently reduce lactose content, increase GOS and probiotics content and lower acidity of the fermented milk products.

### SUMMARY OF THE INVENTION

The present invention provides a process for preparing a functional fermented milk product comprising treating milk materials with a lactase to provide enzyme-hydrolyzed milk materials, treating the enzyme-hydrolyzed milk materials with Bifidobacterium to provide fermented milk materials, and further treating the fermented milk materials to provide a functional fermented milk product.

One of the features of the invention is treating milk materials with lactase to reduce the lactose content of the milk materials and simultaneously increase GOS content. The process of the present invention (1) reduces the lactose content and (2) increases GOS content of the milk materials in a single step. The enzyme-hydrolyzed milk materials obtained by the process of the present invention are enhanced with GOS, so there is no need to further add GOS when the enzyme-hydrolyzed milk materials are subjected to fermentation by Bifidobacterium. GOS can be used as prebiotics, which promotes the growth of probiotics and combines with probiotics to arrive at synbiotics.

Another feature of the present invention is treating the milk materials with enzyme hydrolysis and lactic acid bacteria fermentation sequentially, so that the lactose content of the milk materials can be reduced in a two-step manner and a lactose-free product which contains less than 0.8% (w/w) lactose can thus be obtained. Reducing the lactose content in milk materials is advantageous, for example, lactose intolerance in the subject who consumes the milk materials can be avoided.

Another feature of the present invention is that treating the milk materials with lactase to obtain enzyme-hydrolyzed milk materials before the lactic fermentation reaction considerably reduces the time required for the lactic fermentation reaction. The reaction time of the process of the present invention to reach the targeted bacterial amount is 8 to 10 hours less than that required for the lactic fermentation reaction wherein the milk materials have not been treated with lactase. The present inventors unexpectedly discovered the advantages of using enzyme-hydrolyzed milk materials.

Another feature of the present invention is that culturing Bifidobacterium in the enzyme-hydrolyzed milk materials of the present invention can result in fermented milk materials of low acidity (i.e., a higher pH value).

Therefore, the fermented milk products produced with the process of the present invention is characterized by low acidity, low lactose content, and being enhanced with GOS and Bifidobacterium.

One of the objects of the present invention is to provide a process for preparing a fermented milk materials with low acidity, low lactose content and high GOS content comprising treating milk materials with a lactase to hydrolyze most lactose in the milk materials, and then produce therewith fermented milk materials with low lactose content and high GOS content.

Another object of the present invention is to hydrolyze most lactose in the milk materials with lactase, so that the milk materials are converted to enzyme-hydrolyzed milk materials that are more easily to be utilized in the following lactic fermentation reaction and the reaction time can be reduced.

The “milk materials” used in the invention may be from any mammals and include, but are not limited to, milk materials from cows, goats or sheep. More preferably, the milk materials are cow's milk. The milk used in the invention can be modified before being treated by the process of the invention. For example, the milk materials can be converted to reduced-fat milk, low-fat milk, skim milk, whey proteins, whey, lactoferrin, or lactose.

Milk materials of the invention can be processed to dried milk materials by drying processes, e.g., heat-drying and freeze-drying. The dried milk materials can be dissolved in water before being used as milk materials in the enzymatic hydrolysis reaction and lactic fermentation reaction of the invention.

The milk materials used in the process of the invention can be highly concentrated.

In one embodiment of the invention, the milk materials used in the process contain about 10% to 40% (w/w) of solid content. In a preferred embodiment of the invention, the milk materials used in the process contain about 20% to 40% (w/w) of solid content. In one embodiment of the invention, the milk materials used in the process of the invention contain about 10% (w/w) of solid content. In one embodiment of the invention, the milk materials used in the process of the invention contain about 40% (w/w) of solid content.

The “enzyme-hydrolyzed milk materials” used in the invention refer to the milk materials that have been treated with lactase. In accordance with the process of the invention, about 0.1 to 1% (w/w) lactase, based on the amount of lactose of the milk materials, is used to treat the milk materials to obtain enzyme-hydrolyzed milk materials.

Preferably, about 0.1 to 0.5% (w/w) lactase is used. More preferably, about 0.1 to 0.3% (w/w) lactase is used. The process of the invention makes use of lactases from any origin, including, but not limited to, lactases from Aspergillus, Saccharomyces and Kluyveromyces. In accordance with one embodiment of the invention, the lactase is β-galactosidase. In accordance with one embodiment of the invention, the activity of the lactase is preferably 3000 to 5000 U/g. According to the embodiments of the invention, the enzymatic hydrolysis reaction is carried out at a temperature between about 40° C. to 50° C. for about 60 to 70 minutes.

Any known process can be adopted to terminate enzymatic reactions after enzymatic treatment, for example, heating the resultant enzyme-hydrolyzed milk materials to inactivate the enzymes and then cooling it. The temperature for heating and inactivating the enzymes is about 60° C. to 90° C., preferably 80° C. to 90° C., and more preferably 85° C. to 90° C. After enzyme inactivation, the temperature is cooled to about 10° C. to 20° C. , preferably 10° C. .

The enzyme-hydrolyzed milk materials of the invention have about 10% to 40% (w/w) solid content, preferably about 18% to 40% (w/w). The enzyme-hydrolyzed milk materials contain about 0.8 to 1.2% (w/w) lactose and about 3.0% to 3.5% (w/w) GOS, preferably about 3.4% (w/w). The enzyme-hydrolyzed milk materials have a pH of about 6.3 to 6.6, preferably a pH of about 6.5.

Treating the enzyme-hydrolyzed milk materials of the invention with lactic acid bacteria to conduct lactic fermentation reaction, so that fermented milk materials can be obtained.

According to one embodiment of the invention, Bifidobacterium is adopted to conduct the lactic fermentation reaction, and the fermented products thus produced have lower acidity. Any Bifidobacterium can be used in the invention, including, but are not limited to, Bifidobacterim bifidum, Bifidobacterim longum, Bifidobacterim breve and Bifidobacterim lactis. According to one embodiment of the invention, Bifidobacterium is Bifidobacterim bifidum. The initial amount of Bifidobacterium is preferably about 1×10⁶ to 3×10⁶ CFU/g. In one embodiment of the invention, the initial amount of Bifidobacterium is about 1.14×10⁶ CFU/g. In another embodiment of the invention, the initial amount of Bifidobacterium is about 2.16×10⁶ CFU/g.

According to the invention, the lactic fermentation reaction is carried out at a temperature between about 36° C. to 38° C. for 10 to 24 hours, preferably at 37° C. for 10 hours. The reaction time of the lactic fermentation of the invention to reach the targeted bacterial amount is 8 to 10 hours less than that required for the method disclosed in prior art.

In another embodiment of the invention, about 0.5% to 5.0% (w/w) FOS, based on the weight of the milk materials, is added before the lactic fermentation reaction. Preferably, about 2.0% (w/w) FOS is added. The FOS can be used as prebiotics that promote the growth of the probiotics, thus reducing the utilization of GOS in the milk materials by the lactic acid bacteria and increasing the amount of GOS in the end products. Since GOS is resistant to acidity and heat, it can be retained in the end products so the functionality of the end products is increased.

The lactic fermentation reaction can be practiced on the basis of reaction conditions of fermentation reaction known by persons having ordinary skill in the art. As can be appreciated by persons having ordinary skill in the art, the amount and species of lactic acid bacteria, the reaction temperature and reaction time for the process of the invention can be determined on the basis of the enzyme-hydrolyzed milk materials employed, the amount and species of lactic acid bacteria added, and the desired end products.

Finally, the products obtained can be sterilized by the processes known for treating milk products. For example, the products can be sterilized by pasteurization or Ultra High

Temperature (UHT). Optionally, the end products can be packed in an aseptic cool filling system. The end products can be packaged using the materials including, but are not limited to, Polyethylene terephthalate (PET), polyethylene (PE) and Tetra pack.

The fermented milk materials produced with the process of the invention has about 10% to 40% (w/w) solid content, preferably about 10% to 20% (w/w).

The fermented milk materials produced with the process of the invention contain about 0.4% to 0.8% (w/w), preferably about 0.4% to 0.6% (w/w), lactose per 100 g serving.

The fermented milk materials produced with the process of the invention contain about 2.5% to 5.0% (w/w), preferably about 3.5% to 4.7% (w/w), GOS per 100 g serving.

The fermented milk materials produced with the process of the invention contain about 1×10⁸ to 6×10⁸ CFU/g, preferably 6×10⁸ CFU/g, Bifidobacterim.

According to one embodiment of the invention, adding 2% FOS before fermentation (Example 2-2) increases the amount of Bifidobacterim from 5×10⁸ (Example 2-1) to 6×10⁸ (Example 2-2). According to a preferred embodiment of the invention, adding 2% FOS before fermentation (Example 1-2) increases the amount of Bifidobacterim from 4×10⁸ (Example 1-1) to 6×10⁸ (Example 1-2).

The fermented milk materials produced with the process of the invention have a pH of about 4.3 to 5.5, preferably a pH of about 5.2 to 5.5.

The fermented milk materials can be diluted to obtain fermented milk products. The fermented milk products of the invention (per 240 g serving) contain about 0.2% to 0.4% (w/w), preferably about 0.2% to 0.3% (w/w), lactose, and are substantially lactose-free. The fermented milk products of the invention (per 240 g serving) contain about 10% (w/w) solid content and about 1.2% to 2.5% (w/w), preferably about 1.8% to 2.4% (w/w), GOS. Based on the above, another object of the invention is to provide a functional fermented milk product with low acidity, low content of lactose and enhanced with GOS and Bifidobacterim, which is produced with the process of the invention.

The fermented milk products of the invention can be prepared as milk drinks or milk products which can be preserved under normal temperature or refrigerated. The milk products of the invention can also be used as the base of the food product including ice cream, yogurt, yogurt drinks, flavored milk, milk shakes, functional drinks or snacks.

### DETAILED DESCRIPTION OF THE INVENTION

The following examples are provided to further describe the present invention and by no means limit the invention.

The reaction conditions for Examples 1-1 to 3-2 are disclosed in Table 1 below, comprising the amounts of lactose and GOS of the enzyme-hydrolyzed milk materials, fermented milk materials and fermented milk products produced by the process of the present invention, and comprising the amount of Bifidobacterium bifidum and the pH.

### Example 1-1

Dissolving milk powder in water to form a high concentration milk liquid (containing about 40% (w/w) solid content). Adding a lactase to the milk liquid in an amount of 0.1 g lactase per 100 g lactose. Reacting the mixture for 60 minutes and then heating the mixture to 85° C. to 90° C. to inactivate the enzyme. Diluting the mixture to a concentration containing about 19.9% solid content. The resultant enzyme-hydrolyzed milk materials contain 0.9 g lactose and 3.3 g GOS per 100 g enzyme-hydrolyzed milk materials. Adding 3×10⁶ (CFU/g) B. bifidum to the enzyme-hydrolyzed milk materials and fermenting at 37° C. for 10 hours. The resultant fermented milk materials contain 0.5 g lactose and 2.6 g GOS per 100 g fermented milk materials and 4×10⁸ B. bifidum (CFU/g) and have a pH of 5.2.

### Example 1-2

Dissolving milk powder in water to form a high concentration milk liquid (containing about 40% (w/w) solid content). Adding a lactase to the milk liquid in an amount of 0.1 g lactase per 100 g lactose. Reacting the mixture for 60 minutes and then heating the mixture to 85° C. to 90° C. to inactivate the enzyme. Diluting the mixture to a concentration containing about 20% solid content. The resultant enzyme-hydrolyzed milk materials contain 0.9 g lactose and 3.3 g GOS per 100 g enzyme-hydrolyzed milk materials. Adding about 2% (w/w) FOS before conducting the lactic fermentation reaction. Then adding 3×10⁶ (CFU/g) B. bifidum to the enzyme-hydrolyzed milk materials and fermenting at 37° C. for 10 hours. The resultant fermented milk materials contain 0.6 g lactose and 3.5 g GOS per 100 g fermented milk materials and 6×10⁸ B. bifidum (CFU/g) and have a pH of 5.1.

### Example 2-1

Dissolving milk powder in water to form a high concentration milk liquid (containing about 40% (w/w) solid content). Adding a lactase to the milk liquid in an amount of 0.1 g lactase per 100 g lactose. Reacting the mixture for 60 minutes and then heating the mixture to 85° C. to 90° C. to inactivate the enzyme. Diluting the mixture to a concentration containing about 20.23% solid content. The resultant enzyme-hydrolyzed milk materials contain 0.9 g lactose and 3.2 g GOS per 100 g enzyme-hydrolyzed milk materials. Adding 2.8×10⁶ (CFU/g) B. bifidum to the enzyme-hydrolyzed milk materials and fermenting at 37° C. for 10 hours. The resultant fermented milk materials contain 0.5 g lactose and 2.5 g GOS per 100 g fermented milk materials and 5×10⁸ B. bifidum (CFU/g) and have a pH of 5.2.

### Example 2-2

Dissolving milk powder in water to form a high concentration milk liquid (containing about 40% (w/w) solid content). Adding a lactase to the milk liquid in an amount of 0.1 g lactase per 100 g lactose. Reacting the mixture for 60 minutes and then heating the mixture to 85° C. to 90° C. to inactivate the enzyme. Diluting the mixture to a concentration containing about 20.51% solid content. The resultant enzyme-hydrolyzed milk materials contain 0.9 g lactose and 3.2 g GOS per 100 g enzyme-hydrolyzed milk materials. Adding about 2% (w/w) FOS before conducting the lactic fermentation reaction. Then adding 2.8×10⁶ (CFU/g) B. bifidum to the enzyme-hydrolyzed milk materials and fermenting at 37° C. for 10 hours. The resultant fermented milk materials contain 0.6 g lactose and 3.6 g GOS per 100 g fermented milk materials and 6×10⁸ B. bifidum (CFU/g) and have a pH of 5.1.

### Example 3-1

Dissolving milk powder in water to form a high concentration milk liquid (containing about 40% (w/w) solid content). Adding a lactase to the milk liquid in an amount of 0.1 g lactase per 100 g lactose. Reacting the mixture for 60 minutes and then heating the mixture to 85° C. to 90° C. to inactivate the enzyme. Diluting the mixture to a concentration containing about 20% solid content. The resultant enzyme-hydrolyzed milk materials contain 1.0 g lactose and 3.4 g GOS per 100 g enzyme-hydrolyzed milk materials. Adding 1.14×10⁶ (CFU/g) B. bifidum to the enzyme-hydrolyzed milk materials and fermenting at 37° C. for 10 hours. The resultant fermented milk materials contain 0.6 g lactose and 2.8 g GOS per 100 g fermented milk materials and 0.9×10⁸ B. bifidum (CFU/g) and have a pH of 5.2.

### Example 3-2

Dissolving milk powder in water to form a high concentration milk liquid (containing about 40% (w/w) solid content). Adding a lactase to the milk liquid in an amount of 0.1 g lactase per 100 g lactose. Reacting the mixture for 60 minutes and then heating the mixture to 85° C. to 90° C. to inactivate the enzyme. Diluting the mixture to a concentration containing about 20.47% solid content. The resultant enzyme-hydrolyzed milk materials contain 1.0 g lactose and 3.4 g GOS per 100 g enzyme-hydrolyzed milk materials. Adding about 2% (w/w) FOS before conducting the lactic fermentation reaction. Then adding 1.14×10⁶ (CFU/g) B. bifidum to the enzyme-hydrolyzed milk materials and fermenting at 37° C. for 10 hours. The resultant fermented milk materials contain 0.8 g lactose and 4.7 g GOS per 100 g fermented milk materials and 1×10⁸ B. bifidum (CFU/g) and have a pH of 5.3.

The milk materials obtained at each stage of Examples 1-1 to 3-2 and the amount of GOS, lactose and B. bifidum and pH are disclosed in Table 1 below.

TABLE 1
Summarized Process of The Present Invention
milk materials → lactase hydrolysis → inactivation of enzyme by heat → enzyme-hydrolyzed milk
materials → lactic fermentation → fermented milk materials → dilution → fermented milk products

| | | | | | | | | fermented milk | |
|---|---|---|---|---|---|---|---|---|---|
| | | | | | | | | products | |
| | enzyme-hydrolyzed milk | | | fermented milk materials | | | | (10% solid content) | |
| | materials (20% solid content) | | | (20% solid content) | | | | 240 g | |
| | | Galacto- | Fructo- | | Galacto- | | | | Galacto- |
| | | oligo- | oligo- | | oligo- | B. | | | oligo- |
| | Lactose | saccharide | saccharide | Lactose | saccharide | bifidum | | Lactose | saccharide |
| Example | (g/100 g) | (g/100 g) | (g/100 g) | (g/100 g) | (g/100 g) | (CFU/g) | pH | (g/100 g) | (g/100 g) |
| 1-1 | 0.9 | 3.3 | 0 | 0.5 | 2.6 | 4 × 10⁸ | 5.2 | 0.3 | 1.3 |
| 1-2 | 0.9 | 3.3 | 2 | 0.6 | 3.5 | 6 × 10⁸ | 5.1 | 0.3 | 1.8 |
| 2-1 | 0.9 | 3.2 | 0 | 0.5 | 2.5 | 5 × 10⁸ | 5.2 | 0.3 | 1.3 |
| 2-2 | 0.9 | 3.2 | 2 | 0.6 | 3.6 | 6 × 10⁸ | 5.1 | 0.3 | 1.8 |
| 3-1 | 1.0 | 3.4 | 0 | 0.6 | 2.8 | 0.9 × 10⁸ | 5.2 | 0.3 | 1.4 |
| 3-2 | 1.0 | 3.4 | 2 | 0.8 | 4.7 | 1 × 10⁸ | 5.3 | 0.4 | 2.4 |

Sterilizing the fermented milk products obtained in Examples 1-1 to 3-2 by UHT (at a temperature of 140° C. for 30 seconds) and packing it in an aseptic cool filling system.

The above is merely exemplary embodiments of the invention and should not be construed as limitation of the present invention. Moreover, it will be understood that modifications and variations can be made by those of ordinary skill in the art without departing from the spirit and scope of the invention.

1. A process for preparing a functional fermented milk product with low acidity and a low lactose content and enhanced with galactooligosaccharides and Bifidobacterium, comprising:
conducting an enzymatic hydrolysis reaction by directly treating milk materials with a lactase to provide enzyme-hydrolyzed milk materials;
conducting a lactic fermentation reaction by treating the enzyme-hydrolyzed milk materials with Bifidobacterium to provide fermented milk materials, wherein the fermented milk materials have a pH of 4.3 to 5.5; and
treating the fermented milk materials to provide a functional fermented milk product.

2. The process of claim 1, wherein the milk materials are derived from cow's milk, goat's milk or sheep's milk.

3. The process of claim 1, wherein the milk materials comprises a 10% to 40% (w/w) solid content.

4. The process of claim 1, wherein the lactase is β-galactosidase.

5. The process of claim 1, wherein the amount of lactase is 0.1 to 1% (w/w) of the lactose contained in the milk materials.

6. The process of claim 1, wherein the enzymatic hydrolysis reaction is carried out at a temperature of 40° C. to 50° C. for 60 to 70 minutes.

7. The process of claim 1, further comprising a step of heating the enzyme-hydrolyzed milk materials to 60° C. to 90° C. and then cooling to 10° C. to 20° C.

8. The process of claim 1, further comprising a step of adding water to the enzyme-hydrolyzed milk materials to make a 2-fold or 4-fold dilution.

9. The process of claim 1, wherein the enzyme-hydrolyzed milk materials comprise a 10% to 40% (w/w) solid content, 0.8% to 1.2% (w/w) lactose and 3.0% to 3.5% (w/w) galactooligosaccharide.

10. The process of claim 1, wherein the amount of Bifidobacterium added is 1×10⁶ to 3×10⁶ CFU/g, and wherein the Bifidobacterium is Bifidobacterium Bifidum Bifidobacterim longum Bifidobacterim breve or Bifidobacterim lactis.

11. The process of claim 1, further comprising a step of adding 0.5% to 5% (w/w) fructooligosaccharide during the lactic fermentation reaction.

12. The process of claim 1, wherein the lactic fermentation reaction is carried out at a temperature of 36° C. to 38° C. for 10 to 24 hours.

13. The process of claim 1, wherein the fermented milk materials comprise a 10% to 40% (w/w) solid content, 0.4% to 0.8% (w/w) lactose and 2.5% to 5.0% (w/w) galactooligosaccharide.

14. The process of claim 1, wherein the fermented milk materials comprise 1×10⁸ to 6×10⁸ CFU/g Bifidobacterium.

15. The process of claim 1, wherein the fermented milk materials have a pH of 5.2 to 5.5.

16. The process of claim 1, wherein the fermented milk product comprises a 10% (w/w) solid content, 0.2% to 0.4% (w/w) lactose and 1.2% to 2.5% (w/w) galactooligosaccharide.

17. The process of claim 1, further comprising sterilization treatment of the fermented milk product by Ultra High Temperature (UHT).

18. The process of claim 1, further comprising packing the resultant fermented milk product in an aseptic cool filling system.

19. A fermented milk product with low acidity and a low lactose content and enhanced with galactooligosaccharides and Bifidobacterium, produced by the process of claim 1.

20. The fermented milk product of claim 19, which can be used as a base to make ice cream, yogurt, yogurt drinks, flavored milk, milk shakes, snacks or functional drinks.
